(19) United States
(12) Patent Application Publication
(10) Pub. No.: US 2014/0185666 A1
(43) Pub. Date: Jul. 3, 2014

(54) APPARATUS AND METHOD FOR MOVING IMAGE ENCODING AND APPARATUS AND METHOD FOR MOVING IMAGE DECODING

(71) Applicant: Kabushiki Kaisha Toshiba, Minato-ku (JP)

(72) Inventors: Takashi WATANABE, Yokohama-Shi (JP); Tomoo YAMAKAGE, Yokohama-Shi (JP); Wataru ASANO, Yokohama-Shi (JP); Akiyuki TANIZAWA, Kawasaki-Shi (JP); Taichiro SHIODERA, Tokyo (JP)

(73) Assignee: Kabushiki Kaisha Toshiba, Minato-ku (JP)

(21) Appl. No.: 14/196,685

(22) Filed: Mar. 4, 2014

Related U.S. Application Data
(63) Continuation of application No. PCT/JP2012/055230, filed on Mar. 1, 2012.

(30) Foreign Application Priority Data
Sep. 6, 2011 (JP) 2011-194295

(51) Int. Cl. H04N 19/182; H04N 19/136

(52) U.S. Cl. CPC H04N 19/00303; H04N 19/00139
USPC 375/240.02

(57) ABSTRACT

According to certain embodiment, there is provided a moving image encoding apparatus in which a first encoding unit performs a first encoding process on an input image to generate first encoded data and to perform a first decoding process on the first encoded data to generate a first decoded image, a difference calculating unit generates a difference image between the input image and the first decoded image, a first pixel range converting unit converts pixel values of the difference image to be within a first specific range to generate a first converted image, a second encoding unit performs a second encoding process on the first converted image to generate second encoded data, the second encoding process being different from the first encoding process and the first specific range is a range including a range of pixel values that can be encoded by the second encoding unit.

### CROSS REFERENCE TO RELATED APPLICATIONS

This application is a Continuation of International Application No. PCT/JP2012/055230, filed on Mar. 1, 2012, which claims the benefit of priority from Japanese Patent Application No. 2011-194295, filed on Sep. 6, 2011 the entire contents of which is hereby incorporated by reference.

### FIELD

Embodiments describe herein relates to a moving image encoding apparatus to be used for encoding a moving image and a method therefor, and to a moving image decoding apparatus to be used for decoding a moving image and a method therefor.

### BACKGROUND

MPEG-2 specifies a profile for a scalable encoding that implements the scalability for resolution, objective image quality and frame rate. The scalable encoding in MPEG-2 implements the scalability, by adding expansion data, which is called an enhancement layer, to data typically encoded in MPEG-2, which is called a base layer.

Further, in High Efficiency Video Coding (hereinafter, HEVC), which is currently being developed, there has been proposed a framework for implementing the scalability, which has a mode in which the base layer is encoded in H.264/AVC (hereinafter, H.264) and the enhancement layer is encoded in HEVC.

By performing an IP transmission of the expansion data for a digital broadcast encoded in MPEG-2, the quality of a picture can be enhanced. However, MPEG-2 has a low encoding efficiency compared to H.264 and HEVC, and the code amount of the expansion data becomes large.

Meanwhile, although a framework that implements the scalable encoding by the combination of H.264 and HEVC has been proposed, it cannot support an arbitrary codec combination, for example, MPEG-2 and HEVC.

### BRIEF DESCRIPTION OF THE DRAWINGS

FIG. 1 is a block diagram showing a configuration of a moving image encoding apparatus 100 according to a first embodiment;

FIG. 2 is a block diagram showing a configuration of a moving image decoding apparatus 200 according to a second embodiment;

FIG. 3 is a block diagram showing a configuration of a moving image encoding apparatus 300 according to a third embodiment;

FIG. 4 is a block diagram showing a configuration of a moving image decoding apparatus 400 according to a fourth embodiment;

FIG. 5 is a block diagram showing a configuration of a moving image encoding apparatus 500 according to a fifth embodiment;

FIG. 6 is a block diagram showing a configuration of a moving image decoding apparatus 600 according to a sixth embodiment;

FIG. 7 is a block diagram showing a configuration of a moving image encoding apparatus 700 according to a seventh embodiment;

FIG. 8 is a block diagram showing a configuration of a moving image decoding apparatus 800 according to an eighth embodiment;

FIG. 9 is a block diagram showing a configuration of a moving image encoding apparatus 900 according to a ninth embodiment;

FIG. 10 is a block diagram showing a configuration of a moving image decoding apparatus 1000 according to a tenth embodiment;

FIG. 11 is a block diagram showing a configuration of a moving image encoding apparatus 1100 according to an eleventh embodiment;

FIG. 12 is a diagram showing an example of a frame-rate scalability implementation method in the eleventh embodiment;

FIG. 13 is a block diagram showing a configuration of a moving image decoding apparatus 1200 according to a twelfth embodiment;

FIG. 14 is a block diagram showing a configuration of a moving image encoding apparatus 1300 according to a thirteenth embodiment; and

FIG. 15 is a block diagram showing a configuration of a moving image decoding apparatus 1400 according to a fourteenth embodiment.

### DETAILED DESCRIPTION

According to certain embodiment, there is provided a moving image encoding apparatus including: a first encoding unit, a difference calculating unit, a first pixel range converting unit and a second encoding unit.

The first encoding unit performs a first encoding process on an input image to generate first encoded data and to perform a first decoding process on the first encoded data to generate a first decoded image.

The difference calculating unit generates a difference image between the input image and the first decoded image.

The first pixel range converting unit converts pixel values of the difference image to be within a first specific range to generate a first converted image.

The second encoding unit performs a second encoding process on the first converted image to generate second encoded data, the second encoding process being different from the first encoding process.

The first specific range is a range including a range of pixel values that can be encoded by the second encoding unit.

Hereinafter, moving image encoding methods and decoding methods according to the embodiments will be described in detail, with reference to the drawings. Here, in the following embodiments, parts to which the same reference numerals are assigned perform the same operations, and thereby repetitive descriptions are appropriately omitted.

### First Embodiment

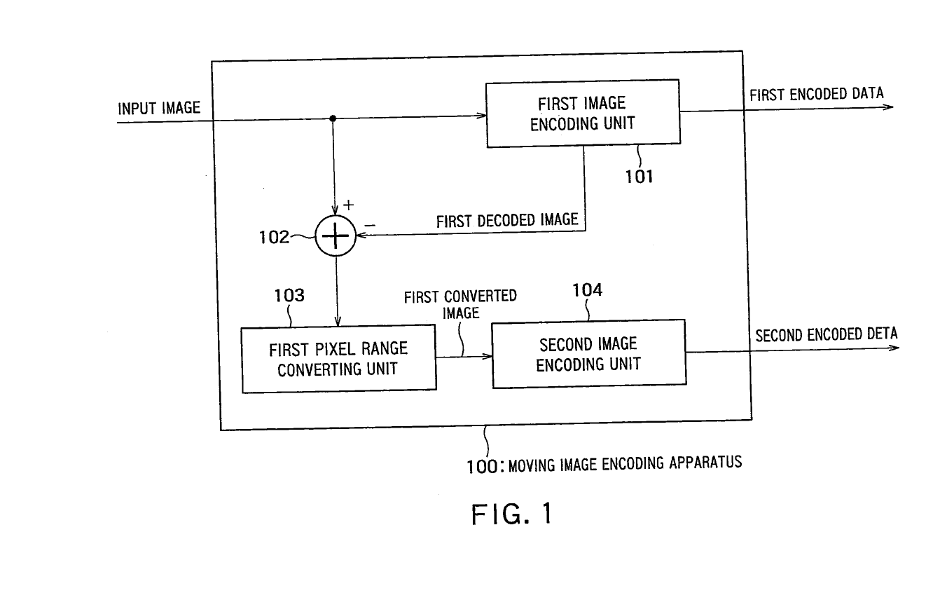

A moving image encoding apparatus according to the embodiment will be described in detail with reference to FIG. 1.

A moving image encoding apparatus 100 according to the embodiment includes a first image encoding unit 101, a subtracting unit (difference calculating unit) 102, a first pixel range converting unit 103 and a second image encoding unit 104.

The first image encoding unit 101 performs a predetermined moving image encoding process on an image (hereinafter, an input image) that is input from the exterior and that includes a plurality of pixel signals, to generate first encoded data. Further, the first image encoding unit 101 performs a predetermined moving image decoding process on the first encoded data to generate first decoded image.

The subtracting unit (difference calculating unit) 102 receives the input image, and the first decoded image from the first image encoding unit 101, and calculates the difference between the input image and the first decoded image to generate a difference image.

The first pixel range, converting unit 103 receives the difference image from the subtracting unit 102, and performs a pixel value conversion for each pixel contained in the difference image such that the pixel value is in a specific range (a first specific range), to generate a first converted image. The specific range is a pixel value range in which the second image encoding unit 104 can perform an encoding, that is, a pixel value range that the second image encoding unit 104 supports as the input.

The second image encoding unit 104 receives the first converted image from the first pixel range converting unit 103, and performs a predetermined moving image encoding process to generate second encoded data. In this regard, the second image encoding unit 104 performs the encoding process by a different technique from the first image encoding unit 101.

Next, the encoding process of the moving image encoding apparatus 100 according to the embodiment will be described.

First, the moving image encoding apparatus 100 according to the embodiment receives the input image, and performs an encoding process in the first encoding unit 101. As the encoding process in this case, an arbitrary technique may be used. In the embodiment, MPEG-2, which is an existing codec, is utilized. In the first encoding unit 101, a prediction, a conversion and a quantization are performed on the input image, and then the first encoded data in conformity with the MPEG-2 standard is generated. Furthermore, a local decoding process is performed, and the first decoded image is generated.

Next, in the subtracting unit 102, a subtracting process is performed on the input image, and the first decoded image from the first encoding unit, so that the difference image is generated.

Subsequently, in the first pixel range converting unit 103, the pixel values are converted so that the first converted image is generated. The detail operation of the first pixel range converting unit 103 will be described later.

Finally, in the second image encoding unit 104, an encoding process is performed on the first converted image. In the second image encoding unit 104, also, an arbitrary encoding process may be used. In the embodiment, H.264, which is an existing codec, is utilized.

Unlike the case of performing a scalable encoding by an ordinary codec, the second image encoding unit 104 uses a codec with a higher encoding efficiency than the first image encoding unit 101, and therefore, it is possible to perform a more efficient encoding. Thereby, even in the case where the first encoded data needs to be encoded in MPEG-2, for example, in the case of a digital broadcast, the second encoding data encoded in H.264 is distributed as expansion data by utilizing an IP transmission network or the like, and therefore, it is possible to enhance the quality of the decoded image by a small amount of data.

Further, as described above, the existing codecs are combined, and therefore, in the decoding side, it is possible to utilize a decoding apparatus involving the existing codecs with no change, and decode the first encoded data and the second encoded data.

Although the case of performing the encoding by utilizing MPEG-2 in the first image encoding unit 101 and utilizing H.264 in the second image encoding unit 104 has been described here, the respective image encoding units can be implemented by utilizing arbitrary codecs. However, in that case, a moving image decoding apparatus described later needs to perform the corresponding moving image decoding process.

Here, the operation of the first pixel range converting unit 103, which is a characteristic of the embodiment, will be described in detail. In the embodiment, it is assumed that the pixel value of the input image is expressed by eight bits. That is, each pixel can have a value of 0 to 255. The pixel value of the first decoded image is also in a range of eight bits, and therefore, the difference image generated in the subtracting unit 102 has a value of −255 to 255 and is in a range of nine bits containing negative values. However, general codecs do not support negative values as the input, and therefore, cannot encode the difference image with no change. Hence, it is necessary to convert the pixel values of the difference image such that they are in a pixel range specified by the encoding method of the second image encoding unit.

Specifically, in the embodiment, it is assumed that the second image encoding unit utilizes H.264 and performs the encoding in accordance with generally-used High Profile. Since High Profile of H.264 specifies an eight-bit input of 0 to 255, the pixel value of each pixel of the difference image is converted so as to become a value in the pixel range. Although an arbitrary method may be used for the conversion, the first converted image can be simply generated from the difference image by the following formula. In Formula 1, “a>>b” means that each bit of “a” is shifted to the right by “b” bits. Therefore, “Sₜᵣₐₙₛ₁(x, y)” is “(S_{diff}(x, y)+255)” right-shifted by 1 bit. Thus, by adding a predetermined first value to the pixel values of the difference image and then performing a bit shift of the value after the addition, the conversion of the pixel value can be performed. Here, “255” in Formula 1 corresponds to the predetermined first value.

Sₜᵣₐₙₛ₁(x,y)=(S_{diff}(x,y)+255)>>1 [Formula 1]

Here, “Sₜᵣₐₙₛ₁(x, y)” represents the first converted image, and “S_{diff}(x, y)” represents the pixel value of a pixel “(x, y)” in the difference image. According to the above, the pixel value of each pixel in the first converted image falls within the range of 0 to 255, and it is possible to perform the encoding by a general codec. In this case, “0” corresponds to a predetermined lower limit value and “255” corresponds to a predetermined upper limit value.

Further, the converted image may be generated by performing a clipping after adding a predetermined second value. For example, the pixel range conversion may be performed by the following formula. In Formula 2, “128” corresponds to the above second value.

$${S}_{trans 1} ( x , y ) = clip 3 ( {S}_{diff} ( x , y ) + 128 , 0 , 255 ) \\ clip 3 ( a , b , c ) = \{ \begin{matrix}a ( b <= a <= c ) \\ b ( a < b ) \\ c ( a > c )\end{matrix} \qquad [ Formula 2 ]$$

The difference value of the first decoded image to the input image arises from the deterioration by the encoding process in the first encoding unit 101, and generally the absolute value tends to be small. That is, the pixel values in the difference image can have a value of −255 to 255, but actually concentrate near 0, and a low number of pixels have large values in absolute value, such as −255 or 255. Accordingly, when performing the pixel range conversion using Formula 2, although errors by the conversion arise for pixels having large values in absolute value, the errors do not arise for pixels with small absolute values because of no need to perform the bit shift operation, and in some cases, it is possible to lessen errors arising as a whole, compared to Formula 1.

In the above examples of the pixel range conversion, the case where the codec used in the second image encoding unit 104 specifies an eight-bit input has been described. Actually, the numerical example varies depending on a codec to be utilized. In addition, there is a need to consider not only the specification of the codec but also the pixel value range that the whole system can deal with.

In the embodiment, the scalability implementation scheme of performing the pixel range conversion of the difference image calculated from the first decoded image and the input image and then performing the encoding, has been described. However, the second image encoding unit 104 may further perform a scalable encoding. For example, H.264/SVC, which is a scalable encoding in H.264, is utilized, and the first converted image is further divided into a base layer and an enhancement layer, to be encoded. Thereby, it is possible to implement a more flexible scalability.

Furthermore, the above scalability may be implemented by combining a plurality of processes of the first pixel range converting unit 103 and the second image encoding unit 104. A decoded image that is obtained by decoding the second encoded data similarly to a moving image decoding apparatus described later, is inversely converted corresponding to the process of the first pixel range converting unit 103, and then is added to the first decoded image. From the image obtained by this and the input image, a difference image is generated again, and the pixel range conversion and the image encoding process are applied. Thereby, it is possible to implement a further scalability.

### Second Embodiment

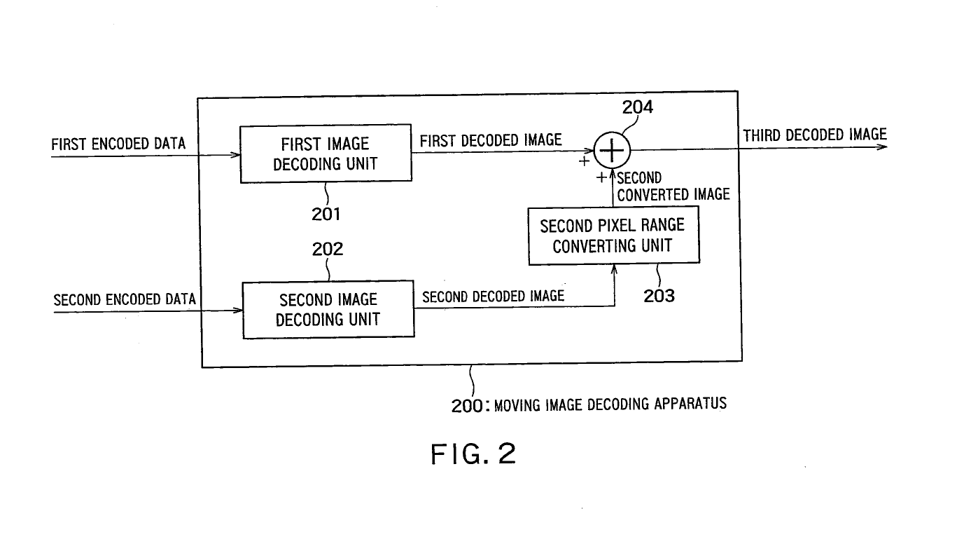

In the embodiment, a moving image decoding apparatus corresponding to the moving image encoding apparatus 100 according to the first embodiment will be described. In the following, the moving image decoding apparatus according to the embodiment will be described in detail with reference to FIG. 2.

A moving image decoding apparatus 200 according to the embodiment includes a first image decoding unit 201, a second image decoding unit 202, a second pixel range converting unit 203 and an adding unit 204.

The first image decoding unit 201 performs a predetermined moving image decoding process on the first encoded data input from the exterior, to generate a first decoded image.

The second image decoding unit 202 performs a predetermined moving image decoding process on the second encoded data input from the exterior, to generate a second decoded image. In this regard, the second image decoding unit 202 performs the decoding process by a different technique from the first image decoding unit 201.

The second pixel range converting unit 203 receives the second decoded image from the second image decoding unit 202, and performs a pixel value conversion for each pixel contained in the second decoded image such that the pixel value is in a specific range, to generate a second converted image.

The adding unit 204 receives the first decoded image and the second converted image from the first image decoding unit 201 and the second pixel range converting unit 203, respectively, and adds pixel values of the first decoded image and the second converted image to generate a third decoded image.

Next, the decoding process of the moving image decoding apparatus 200 according to the embodiment will be described.

First, the moving image decoding apparatus 200 according to the embodiment receives the first encoded data, and performs a decoding process in the first image decoding unit 201. At this time, in the first image decoding unit 201, the decoding process corresponding to the encoding process that is performed in the first image encoding unit 101 of the moving image encoding apparatus 100 in FIG. 1 is performed. In the first embodiment, the first image encoding unit 101 utilizes MPEG-2 to perform the encoding, and therefore in the embodiment, the first image decoding unit 201 performs the decoding process on the first encoded data in conformity with the MPEG-2 standard, so that the first decoded image is generated.

Next, the moving image decoding apparatus 200 receives the second encoded data, and performs a decoding process in the second image decoding unit 202. At this time, in the second image decoding unit 202, the decoding process corresponding to the encoding process that is performed in the second image encoding unit 104 of the moving image encoding apparatus 100 in FIG. 1 is performed. In the first embodiment, the second image encoding unit 104 utilizes H.264 to perform the encoding, and therefore in the embodiment, the second image decoding unit 202 performs the decoding process on the second encoded data in conformity with the H.264 standard, so that the second decoded image is generated.

Subsequently, in the second pixel range converting unit 203, the pixel value of each pixel of the second decoded image is converted such that the pixel value is in a specific range (a second specific range), so that the second converted image is generated. The detail operation of the second pixel range converting unit 203 will be described later.

Finally, in the adding unit 204, the addition process is performed on the first decoded image and the second converted image, so that the third decoded image is generated.

As described above, the moving image decoding apparatus 200 according to the embodiment independently performs the decoding processes, which correspond to the two different encoding methods performed in the first image encoding unit 101 and the second image encoding unit 104 of the moving image encoding apparatus 100, in the first image decoding unit 201 and the second image decoding unit 202, respectively. Thereby, as described in the first embodiment, it is possible to utilize a decoding apparatus involving the existing codecs with no change.

Here, the operation of the second pixel range converting unit 203, which is a characteristic of the embodiment, will be described in detail. The second pixel range converting unit 203 performs the inverse conversion process corresponding to the conversion process of the first pixel range converting unit 103 in the moving image encoding apparatus 100. As described in the first embodiment, in the first pixel range converting unit 103, Formula 1 is applied to each pixel of the difference image that can have a value of −255 to 255 so that it falls within the range of 0 to 255, and thereafter, the encoding is performed in the second image encoding unit 104. Hence, for the second decoded image, the second pixel range converting unit 203 performs the conversion of the pixel value by the following formula. In Formula 3, “a<<b” means that each bit of “a” is shifted to the left by “b” bits. Therefore, “Sₜᵣₐₙₛ₂(x, y)” is equivalent to the value resulting from left-shifting “S_{dec2}(x, y)” by 1 bit and then subtracting 255.

Sₜᵣₐₙₛ₂(x,y)=(S_{dec2}(x,y)<<1)−255 [Formula 3]

Here, “Sₜᵣₐₙₛ₂(x, y)” represents the second converted image, and “S_{dec2}(x, y)” represents the pixel value of a pixel “(x, y)” in the second decoded image. According to the above, each pixel in the second decoded image that is a value in the range of 0 to 255 is inversely converted to −255 to 255, which is the same pixel range as the difference image calculated in the moving image encoding apparatus 100. That is, this range (the second specific range) is equivalent to the range that is equal to or more than the negative value of the maximum value for possible pixel values of the input image or first decoded image, and that is equal to or less than the maximum value.

Further, in the case where the first pixel range converting unit 103 performs the pixel conversion by Formula 2, the second pixel range converting unit 203 performs the conversion of the pixel value by the following formula.

Sₜᵣₐₙₛ₂(x,y)=(S_{dec2}(x,y)−128 [Formula 4]

The second converted image obtained by the above process is added to the first decoded image, and thereby, it is possible to obtain a third decoded image in which the error to the input image is small compared to the first decoded image.

### Third Embodiment

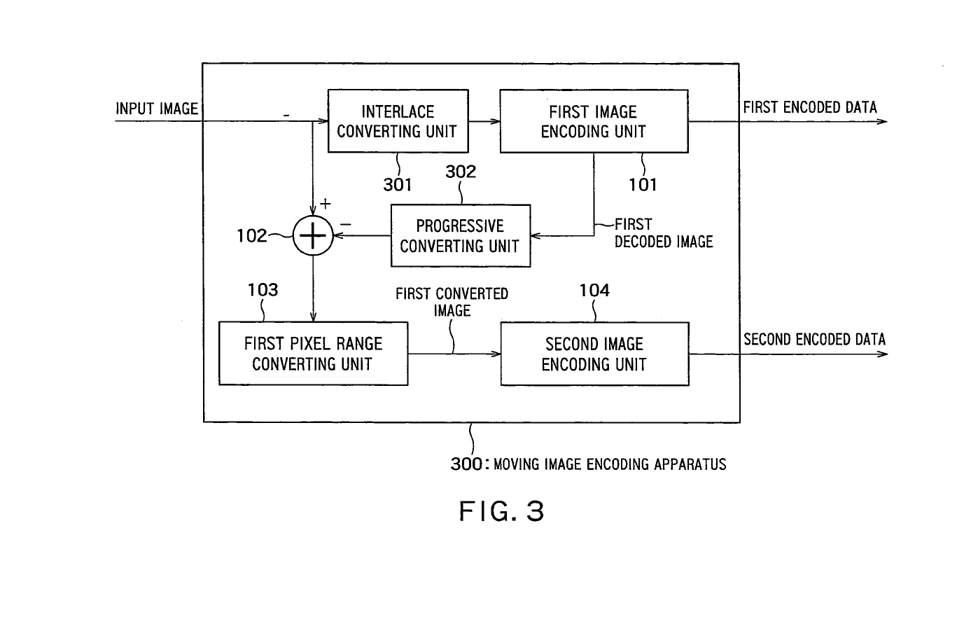

In the embodiment, a modification of the first embodiment will be described. In the following, a moving image encoding apparatus according to the embodiment will be described in detail with reference to FIG. 3.

A moving image encoding apparatus 300 further includes an interlace converting unit 301 and a progressive converting unit 302, in addition to the constituent elements of the moving image encoding apparatus 100.

The interlace converting unit 301 receives the input image, and converts a progressive-format image to an interlace-format image.

The progressive converting unit 302 receives the first decoded image from the first image encoding unit 101, and converts an interlace-format image to a progressive-format image.

In the first embodiment, the format of an image is not particularly limited. However, in the first image encoding unit 101 and the second image encoding unit 104, different image formats may be intended. For example, in the case of assuming a digital broadcast, the first image encoding unit 101 encodes an interlace-format image. On the other hand, the second image encoding unit 104 does not necessarily have to encode an interlace-format image. Further, in the case where the codec used in the second image encoding unit 104 is not H.264, there is a possibility that an interlace-format image is not supported as the input.

In the above case, the first image encoding unit 101 may encode an interlace-format image as the input and the second image encoding unit 104 may encode a progressive-format image as the input. Thereby, the first image encoding unit 101 encodes an image that has been converted to the interlace format by the interlace converting unit 301. Further, the first pixel range converting unit converts the pixel values of the difference between the input image and the first decoded image that has been converted to the progressive format by the progressive converting unit 302, and then the second image encoding unit 104 encodes the image.

The case where the format of the input image is the progressive has been described here. In the case where the input image has the interlace format, the interlace converting unit 301 and the progressive converting unit 302 are unnecessary, and the progressive conversion only has to be performed on the difference image.

Further, the first image encoding unit and the second image encoding unit may have the inverse input formats. In this case, the interlace conversion and the progressive conversion only have to be performed at the corresponding positions.

### Fourth Embodiment

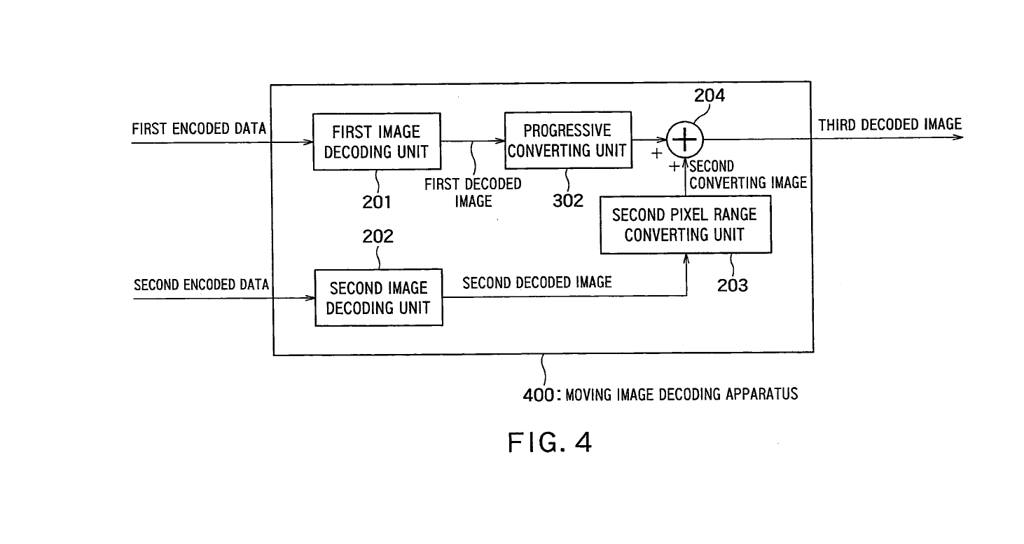

In the embodiment, a moving image decoding apparatus corresponding to the moving image encoding apparatus 300 according to the third embodiment will be described. In the following, the moving image decoding apparatus according to the embodiment will be described in detail with reference to FIG. 4.

A moving image decoding apparatus 400 further includes a progressive converting unit 302 in addition to the constituent elements of the moving image decoding apparatus 200, and the progressive converting unit 302 performs the same process as the moving image encoding apparatus 300.

At this time, similarly to the third embodiment, the progressive conversion is applied to the first decoded image, and thereby it is possible to match the first decoded image in the interlace format and the second converted image in the progressive format. By adding these, even when the first image encoding unit 101 and the second image encoding unit 104 perform the encoding in different image formats, it is possible to obtain the same effect as the first and second embodiments.

### Fifth Embodiment

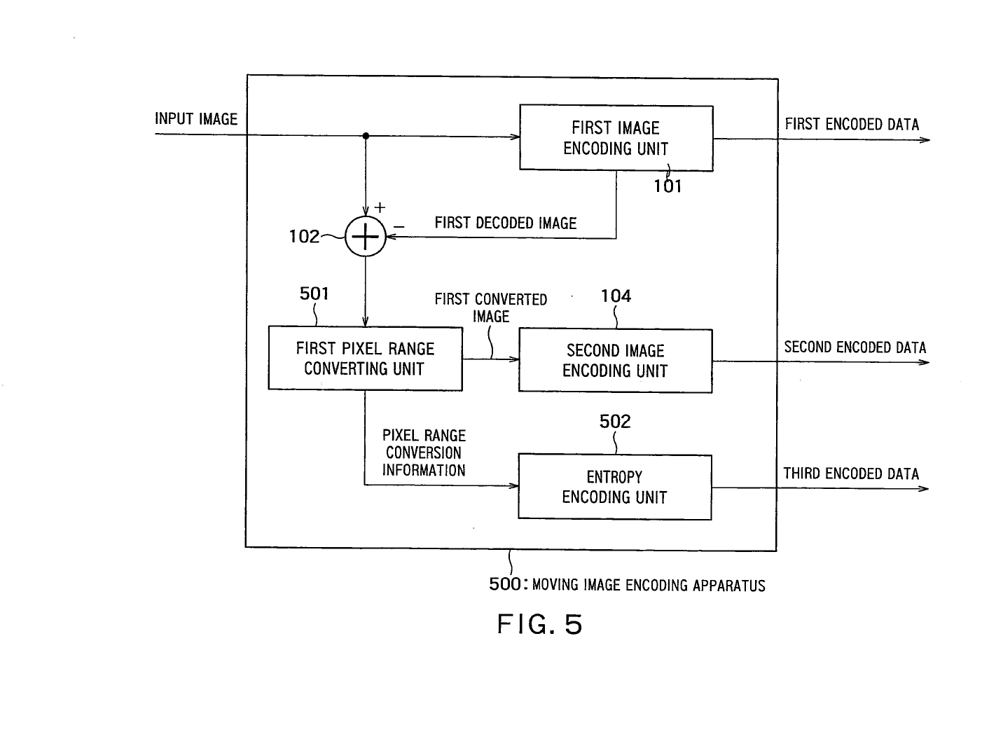

In the embodiment, a modification of the first embodiment will be described. In the following, a moving image encoding apparatus according to the embodiment will be described in detail with reference to FIG. 5.

In a moving image encoding apparatus 500, the first pixel range converting unit 103 of the constituent elements of the moving image encoding apparatus 100 is replaced with a first pixel range converting unit 501 having a different function, and further, an entropy encoding unit 502 is included.

Similarly to the first pixel range converting unit 103 in the moving image encoding apparatus 100, the first pixel range converting unit 501 receives the difference image from the subtracting unit 102, and performs the pixel value conversion for each pixel contained in the difference image such that the pixel value is in a specific range, to generate the first converted image. Furthermore, pixel range conversion information, which is a parameter used when the pixel range conversion is performed, is output.

The entropy encoding unit 502 receives the pixel range conversion information from the first pixel range converting unit 501, and performs a predetermined encoding process to generate third encoded data.

Here, the first pixel range converting unit 501 and the entropy encoding unit 502, which are characteristics of the embodiment, will be described. In the first embodiment, the pixel range conversion is performed by Formula 1. In Formula 1, the conversion is performed, assuming that the pixel values of the difference image have a value of −255 to 255. However, in some cases, all the pixels of the difference image are actually in a narrower range than the above pixel range. In this case, the information of the low 1-bit is necessarily lost by Formula 1 because of the 1-bit shift, and there is a possibility that the information is excessively lost. Hence, in the embodiment, the pixel conversion is performed by the following formula instead of Formula 1.

Sₜᵣₐₙₛ₁(x,y)=(S_{diff}(x,y)−min)*255/(max−min) [Formula 5]

Here, “max” and “min” represent the maximum value and minimum value in all the pixels contained in the difference image, respectively. By using Formula 5, the conversion is performed such that the pixel values are actually in the range of 0 to 255, and therefore, there is an advantage that the information to be lost at the time of the conversion is lessened.

The “max” and “min” used in Formula 5 are output to the entropy encoding unit 502 as the pixel range conversion information. In the entropy encoding unit 502, the encoding process is performed, for example, by a Huffman encoding or an arithmetic encoding, and it is output as the third encoded data.

The case of performing the pixel range conversion by utilizing the maximum value and minimum value of the pixel values contained in the difference image has been described here. The pixel range conversion may be performed using another generally-used tone mapping technique such as a histogram packing. In this case, instead of the maximum value and the minimum value, necessary parameters are encoded as the pixel range conversion information.

The above pixel range conversion information may be encoded in an arbitrary unit such as a frame, a field or a pixel block. For example, in the case of performing the encoding for each pixel block, the maximum value and the minimum value are calculated in a finer unit, compared to a frame or the like. Thereby, the information to be lost by the pixel range conversion is lessened, but meanwhile, the overhead by the encoding of the pixel range conversion information is increased.

Further, although the pixel range converting unit has been described here as being a single thing, a plurality of the above pixel range converting units may be switched and used. As for the switching unit, also, a frame, a field, a pixel block, a pixel and the like are possible. However, it is necessary to perform the pixel range conversion such that the encoding apparatus and the decoding apparatus correspond. Hence, the switching may be performed based on a previously-defined judgmental criterion, or the encoding may be performed in which the pixel range conversion information contains the information such as indexes that indicate the pixel range conversion unit arbitrarily set in the encoding side.

The pixel range conversion information may be the information not only for encoding the parameters to be used in the conversion but also for compensating the information lost by the pixel range conversion. For example, in the case of performing the pixel range conversion in accordance with Formula 1, since the information of the low 1-bit is lost as described above, an error arises between the difference image and the first converted image. Hence, the information of the low 1-bit is separately encoded, and thereby a decoding apparatus described later can compensate the error arisen by the pixel range conversion.

Furthermore, although the case of encoding the pixel range conversion information independently of the first encoded data and the second encoded data to generate the third encoded data has been described here, it is allowable to perform the multiplex with the first encoded data, or the second encoded data. In this regard, it is necessary to conform to the encoding scheme used in the first image encoding unit 101 and the second image encoding unit 104. Hence, for example, in the case of performing the multiplex with the second encoded data that is encoded in H.264, the encoding may be performed by utilizing a User Data Unregistered SEI Message that is supported as a NAL unit capable of freely writing parameters on a Supplemental Enhancement Layer (SEI).

### Sixth Embodiment

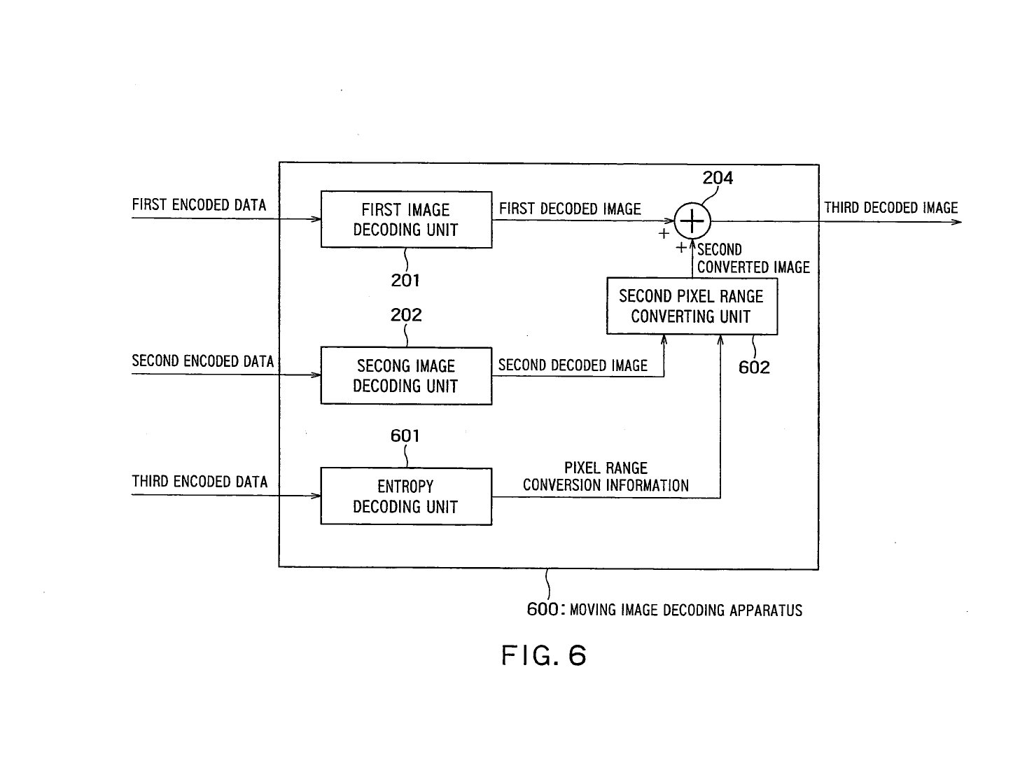

In the embodiment, a moving image decoding apparatus corresponding to the moving image encoding apparatus 500 according to the fifth embodiment will be described. In the following, the moving image decoding apparatus according to the embodiment will be described in detail with reference to FIG. 6.

A moving image decoding apparatus 600 further includes an entropy decoding unit 601 in addition to the constituent elements of the moving image decoding apparatus 200, and the second pixel range converting unit 203 is replaced with a second pixel range converting unit 602 having a different function.

The entropy decoding unit 601 receives the third encoded data, and performs a predetermined decoding process to obtain the pixel range conversion information.

The second pixel range converting unit 602 receives the second decoded image and the pixel range conversion information from the second image decoding unit 202 and the entropy decoding unit 601, respectively, and performs the pixel value conversion for each pixel contained in the second decoded image such that the pixel value is in a specific range, to generate the second converted image.

Here, the entropy decoding unit 601 and the second pixel range converting unit 602, which are characteristics of the embodiment, will be described. For the third encoded data, the entropy decoding unit 601 performs the decoding process corresponding to the encoding process that is performed in the entropy encoding unit 502 of the moving image encoding apparatus 500, and thereby obtains the pixel range conversion information. Here, in the case where the pixel range conversion information is the “max” and “min” in Formula 5, it is possible to perform the inverse conversion process corresponding to the conversion process that is performed in the first pixel range converting unit 501 of the moving image encoding apparatus 500, by the following formula instead of Formula 3.

Sₜᵣₐₙₛ₂(x,y)=S_{dec2}(x,y)*(max−min)/255+min [Formula 6]

By performing the conversion by Formula 6, even when the moving image encoding apparatus 500 performs the pixel range conversion using the maximum value and minimum value of the pixel values contained in the difference image, it is possible to obtain the same effect as the first and second embodiments.

Further, the unit in which the above pixel range conversion information is encoded, the position at which the multiplex is performed, and the switching of a plurality of pixel range converting units are the same as the moving image encoding apparatus 500.

### Seventh Embodiment

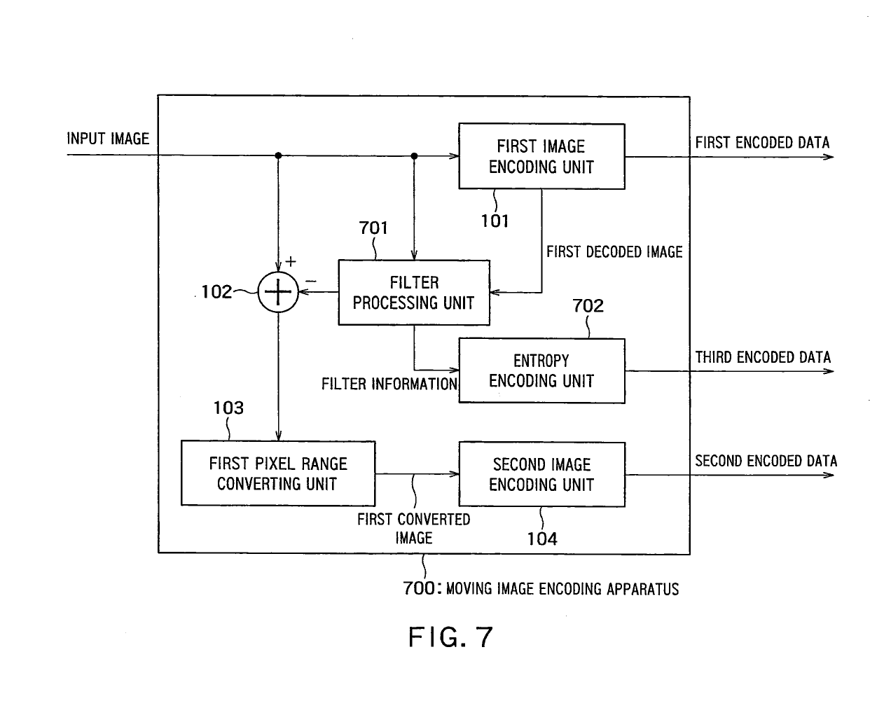

In the embodiment, a modification of the first embodiment will be described. In the following, a moving image encoding apparatus according to the embodiment will be described in detail with reference to FIG. 7.

A moving image encoding apparatus 700 further includes a filter processing unit 701 and an entropy encoding unit 702, in addition to the constituent elements of the moving image encoding apparatus 100.

The filter processing unit 701 receives the input image, and the first decoded image from the first image encoding unit 101, to perform a predetermined filter process on the first decoded image. Furthermore, filter information that indicates a filter used in the process is output.

The entropy encoding unit 702 receives the filter information from the filter processing unit 701, and performs a predetermined encoding process to generate the third encoded data.

Here, the filter processing unit 701 and the entropy encoding unit 702, which are characteristics of the embodiment, will be described. The filter processing unit 701 applies a filter to the first decoded image, and thereby reduces the error between the input image and the first decoded image. For example, the two-dimensional Wiener filter, which is generally used in image restoration, is used in the filter process, and thereby, it is possible to minimize the square error between the input image and the first decoded image to which the filter is applied. The filter processing unit 701 receives the input image and the first decoded image, calculates filter coefficients by the minimum square error criterion, and applied the filter to each pixel of the first decoded image by the following formula.

$${S}_{filt} ( x , y ) = {\sum }_{i} {\sum }_{j} h ( i , j ) {S}_{dec 1} ( x - i , y - j ) \qquad [ Formula 7 ]$$

“S_{filt}(x, y)” represents an image after the filter application, “S_{dec1}(x, y)” represents the pixel value of a pixel “(x, y)” in the first decoded image, and “h(i, j)” represents a filter coefficient. Possible values of “i” and “j” depend on the horizontal and vertical tap lengths of the filter, respectively.

The calculated filter coefficient “h(i, j)” is output to the entropy encoding unit 702 as the filter information. In the entropy encoding unit 702, the encoding process is performed, for example, by a Huffman encoding or an arithmetic encoding, and it is output as the third encoded data. The tap length and shape of the filter may be arbitrarily set in the encoding apparatus 700, and the information indicating these may be encoded while being contained in the filter information. Furthermore, as the information indicating the filter coefficient, the information such as an index that indicates the filter selected from a plurality of previously prepared filters may be encoded instead of the coefficient value itself. However, in this case, a decoding apparatus described later also needs to previously hold the same filter coefficient. Further, the filter process does not need to be performed on all the pixels, and for example, the filter may be applied only to a region in which the filter application reduces the error to the input image. However, since the decoding apparatus described later cannot obtain the information about the input image, it is necessary to separately encode the information indicating the region in which the filter is applied.

The embodiment is different from the first embodiment, in that the difference image is generated between the input image and the image after the filter process. The error to the input image is reduced by performing the filter process, and then the difference image is generated. Thereby, the energy of the pixel values contained in the difference image is lessened, and the encoding efficiency in the second image encoding unit is increased. Furthermore, as the fifth embodiment, in the case of performing the pixel range conversion based on the distribution of the pixel values actually contained in the difference image, the pixel values of the difference image concentrate near 0, and thereby, it is possible to perform a more efficient pixel range conversion and further increase the encoding efficiency.

In the embodiment, the scheme in which the use of the Wiener filter enhances the image quality of the first decoded image has been described, but another known image-quality enhancement process may be used. For example, the bi-liner filter, the non-local means filter or the like may be used, and in this case, parameters about these processes are encoded as the filter information. Furthermore, in the case of performing a common process between the encoding side and the decoding side without adding a parameter, such as the deblock process in H.264, additional information does not necessarily have to be encoded.

Furthermore, although the filter process by a general product-sum operation has been described here, an offset term may be used as one of the filter coefficients. For example, an offset term may be further added to the product-sum by Formula 7, for the filter process result. In the embodiment, a process in which an offset term is merely added is also regarded as a filter process.

Further, although the image-quality enhancement process has been described here as being a single process, a plurality of the above image-quality enhancement processes may be switched and used. Similarly to the switching of the pixel range converting unit in the fifth embodiment, the switching unit may be a frame, a field, a pixel block, a pixel or the like. These may be switched based on a previously-defined judgmental criterion, or the encoding may be performed while the filter information contains the information such as indexes that indicate the image-quality enhancement processes arbitrarily set in the encoding side.

Also, as for the generation method of the encoded data indicating the filter information, as described in the fifth embodiment, the multiplex with the first and second encoded data may be performed.

### Eighth Embodiment

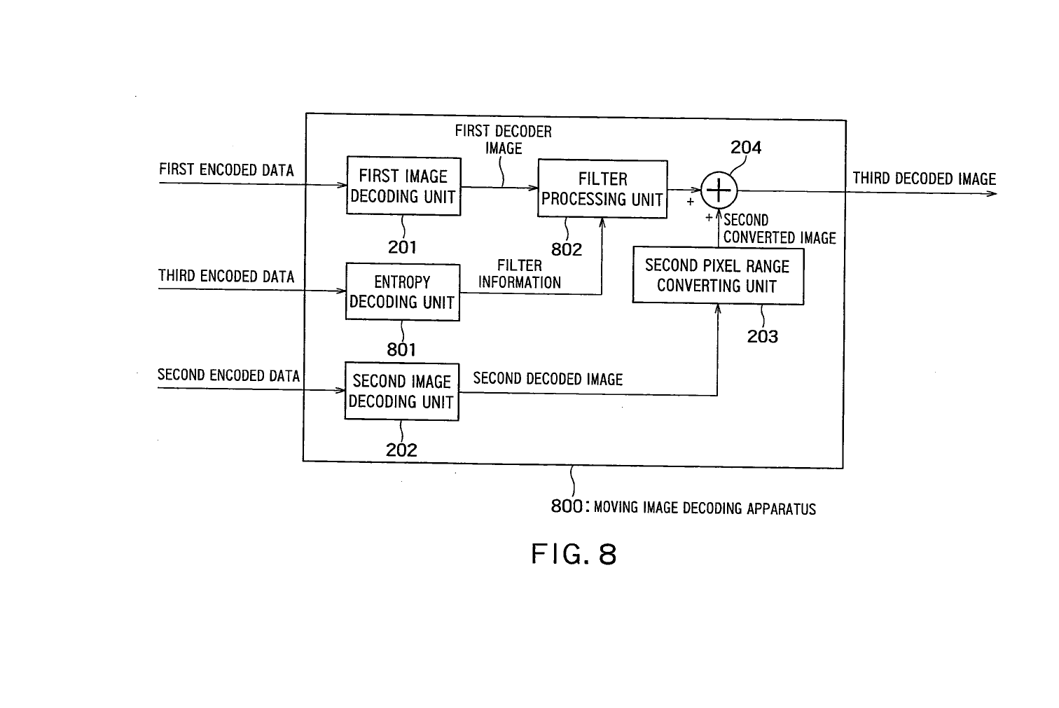

In the embodiment, a moving image decoding apparatus corresponding to the moving image encoding apparatus 700 according to the seventh embodiment will be described. In the following, the moving image decoding apparatus according to the embodiment will be described in detail with reference to FIG. 8.

A moving image decoding apparatus 800 further includes an entropy decoding unit 801 and a filter processing unit 802, in addition to the constituent elements of the moving image decoding apparatus 200.

The entropy decoding unit 801 receives the third decoded data, and performs a predetermined decoding process to obtain the filter information.

The filter processing unit 802 receives the first decoded image and the filter information from the first image decoding unit 201 and the entropy decoding unit 801, respectively, and, for the first decoded image, performs a filter process indicated by the filter information.

Here, the entropy decoding unit 801 and the filter processing unit 802, which are characteristics of the embodiment, will be described. For the third encoding data, the entropy decoding unit 801 performs the decoding process corresponding to the encoding process that is performed in the entropy encoding unit 702 of the moving image encoding apparatus 700, and thereby obtains the filter information. Here, when the filter information is the coefficient of the Wiener filter that is represented by “h(i, j)” in Formula 7, the filter processing unit 802 can perform, for the first decoded image, the same filter process as the encoding apparatus 700, in accordance with Formula 7.

By performing the filter process by Formula 7, even when the filter process is performed on the first decoded image in the moving image encoding apparatus 700, it is possible to obtain the same effect as the first and second embodiments.

Further, the unit in which the above filter information is encoded, the position at which the multiplex is performed, and the switching method of a plurality of image-quality enhancement processes are the same as the moving image encoding apparatus 700.

### Ninth Embodiment

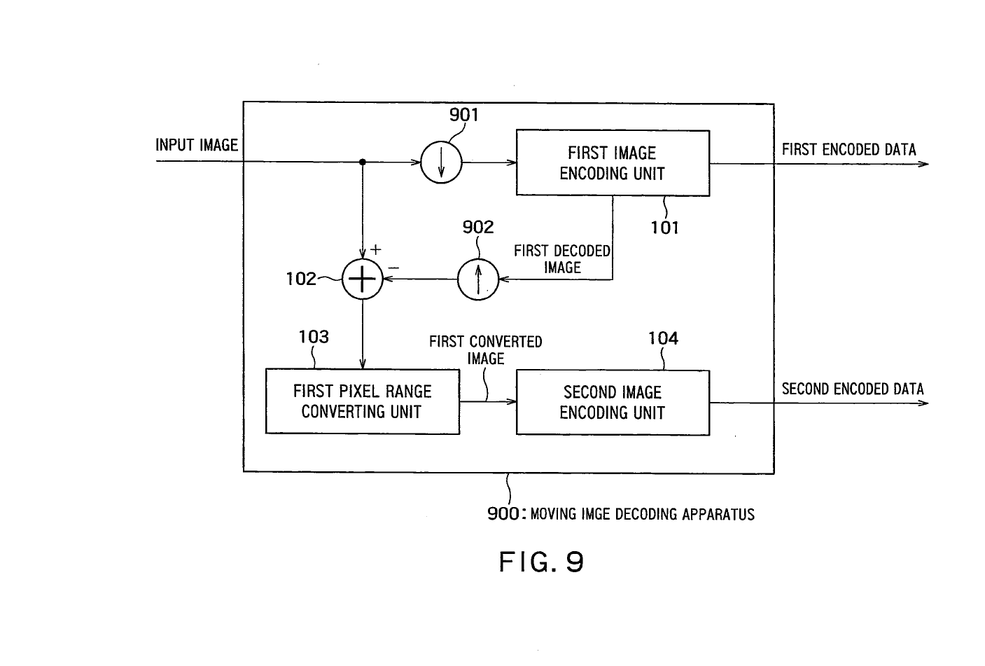

In the embodiment, a modification of the first embodiment will be described. In the following, a moving image encoding apparatus according to the embodiment will be described in detail with reference to FIG. 9.

A moving image encoding apparatus 900 further includes a downsampling unit 901 and an upsampling unit 902, in addition to the constituent elements of the moving image encoding apparatus 100.

The downsampling unit 901 receives the input image, and performs a predetermined downsampling process to output an image whose resolution has been reduced.

The upsampling unit 902 receives the first decoded image from the first image encoding unit 101, and performs a predetermined upsampling process to output an image whose resolution has become equivalent to the input image.

Here, the downsampling unit 901 and the upsampling unit 902, which are characteristics of the embodiment, will be described. The downsampling unit 901 reduces the resolution of the input image. For example, assuming that the first encoded data generated in the first image encoding unit 101 is distributed by a digital broadcast, 1440×1080 pixels are input to the first image encoding unit. Generally, these are upsampled in a receiver side, and thereby are displayed as a picture of 1920×1080 pixels. Hence, for example, in the case where the input image has 1920×1080 pixels, the downsampling unit 901 performs a downsampling process to 1440×1080 pixels. At this time, as the downsampling process, other than a simple subsampling, a downsampling by bilinear or bicubic, or the like may be used, and the downsampling may be performed by a predetermined filter process or wavelet transformation.

For the image whose resolution has been reduced by the above process, the first image encoding unit 101 performs a predetermined encoding process to generate the first encoded data and the first decoded image. At this time, the first decoded image is output as a low-resolution image, but the upsampling unit 902 enhances the resolution and generates the difference image to the input image. Thereby, it is possible to enhance the image quality when displaying the image on a receiver.

As the upsampling process in the upsampling unit 902, an upsampling by bilinear or bicubic may be used, or an upsampling process utilizing a predetermined filter process or a self-similarity of an image may be used. In the case of utilizing a self-similarity of an image, it is allowable to use a generally-used upsampling process, such as a method in which a similar region in a frame of an encoding-target image is extracted and utilized, or a method in which similar regions are extracted from a plurality of frames and a desired phase is reproduced.

The resolution of the input image may be an arbitrary resolution, such as 3840×2160 pixels, which is generally called 4K2K. Thus, by the combination of the resolution of the input image and the resolution of the image output by the downsampling unit 901, it is possible to implement an arbitrary resolution scalability.

As for the upsampling process and the downsampling process in the embodiment, a plurality of the above units may be switched and used. In that case, the switching may be performed based on a previously-defined judgmental criterion, or the information such as indexes that indicate the unit arbitrarily set in the encoding side may be encoded as additional data. As for the encoding method of the additional data, for example, the fifth embodiment can be followed.

### Tenth Embodiment

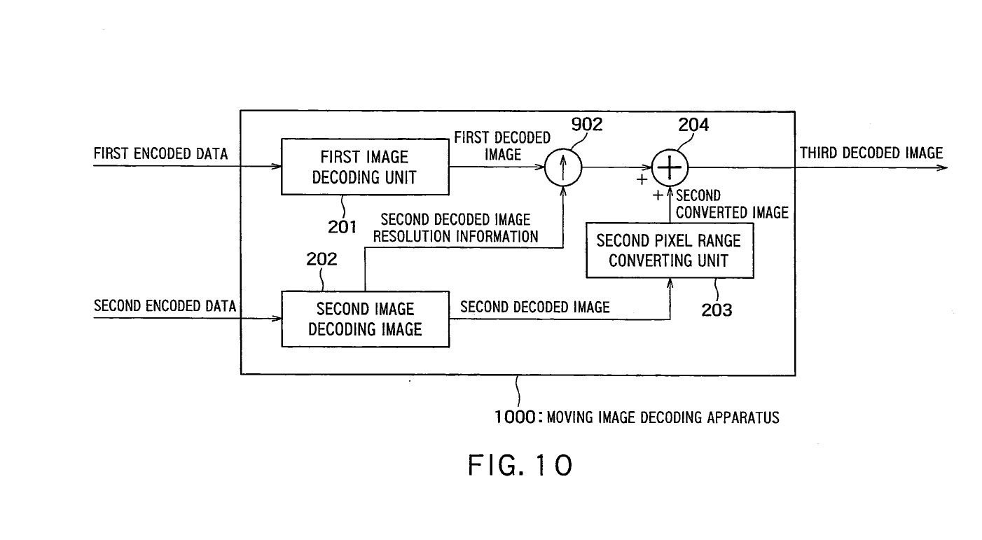

In the embodiment, a moving image decoding apparatus corresponding to the moving image encoding apparatus 900 according to the ninth embodiment will be described. In the following, the moving image decoding apparatus according to the embodiment will be described in detail with reference to FIG. 10.

A moving image decoding apparatus 1000 further includes an upsampling unit 902, in addition to the constituent elements of the moving image decoding apparatus 200.

The upsampling unit 902 receives the first decoded image from the first image decoding unit 201, and performs a predetermined upsampling process to output an image whose resolution has been enhanced.

Here, the upsampling unit 902, which is a characteristic of the embodiment, will be described. As described in the ninth embodiment, here, it is assumed that in the first encoded data and the second encoded data, images with different resolutions are encoded and the first decoded image is an image with a low resolution compared to the second decoded image. The upsampling unit 902 enhances the resolution of the first decoded image by performing, for the first decoded image, the same process as the upsampling unit 902 in the moving image encoding apparatus 900 according to the ninth embodiment. At this time, the first decoded image is upsampled up to the same resolution as the second decoded image. The resolution of the second decoded image is obtained by decoding the second encoded data in the second image decoding unit. The upsampling unit 902 receives the resolution information of the second decoded image from the second image decoding unit, and performs the upsampling process.

In the case of switching and using a plurality of upsampling process units, as for the switching method and the format of additional data, the moving image encoding apparatus 900 can be followed.

### Eleventh Embodiment

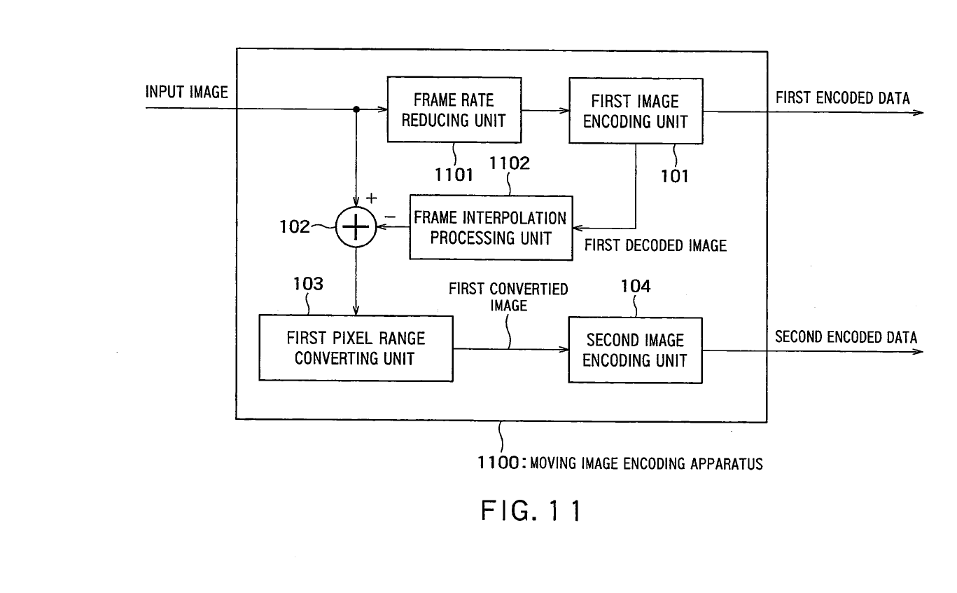

In the embodiment, a modification of the first embodiment will be described. In the following, a moving image encoding apparatus according to the embodiment will be described in detail with reference to FIG. 11.

A moving image encoding apparatus 1100 further includes a frame rate reducing unit 1101 and a frame interpolation processing unit 1102, in addition to the constituent elements of the moving image encoding apparatus 100.

The frame rate reducing unit 1101 receives the input image, and performs a predetermined process to output an image whose frame rate has been reduced.

The frame interpolation processing unit 1102 receives the first decoded image from the first image encoding unit 101, and performs a predetermined process to output an image whose frame rate has been enhanced.

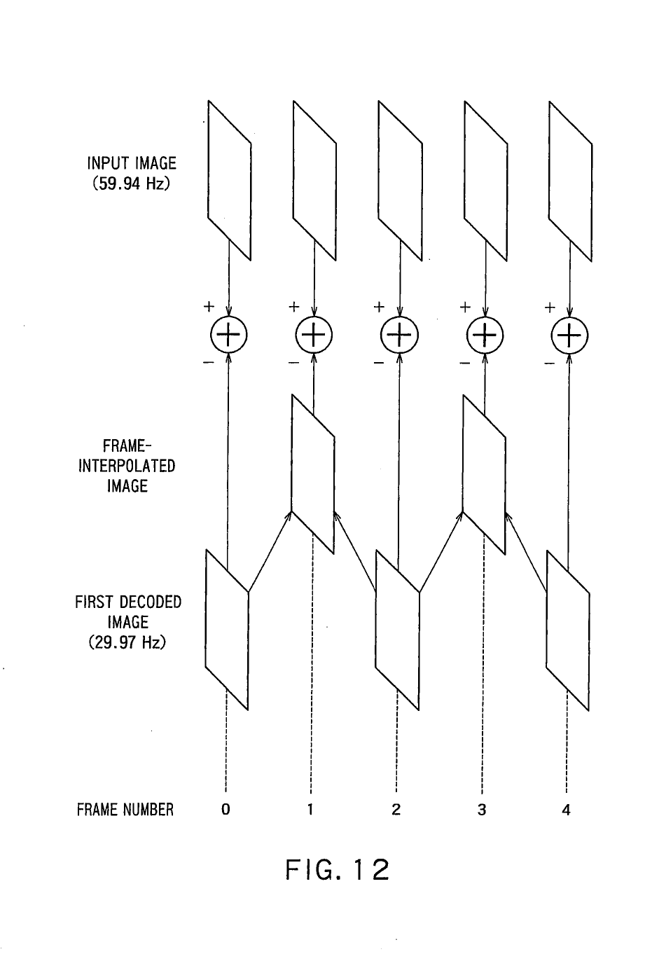

Here, the frame rate reducing unit 1101 and the frame interpolation processing unit 1102, which are characteristics of the embodiment, will be described with reference to FIG. 12.

Assuming that the first encoded data generated in the first image encoding unit 101 is distributed by a digital broadcast, the input frame rate of the first image encoding unit is 29.97 Hz. On the other hand, if the frame rate of the input image is 59.94 Hz, the frame rate reducing unit 1101 reduces the frame rate of the input image to 29.97 Hz. In the reduction of the frame rate, an arbitrary method may be used. In the embodiment, the case of merely thinning frames will be described for simplification. In FIG. 12, only frames with a frame number of “2n” (n=0, 1, 2, . . . ) are input to the first image encoding unit 101 and are encoded, and thereby, the first decoded image can have a frame rate of 29.97 Hz.

Subsequently, the frame interpolation processing unit 1102 performs a frame interpolation process on the first decoded image. As for the frame interpolation process, also, an arbitrary method may be used. In the embodiment, motion information is analyzed from the previous and next frames, and an intermediate frame is generated. By the above frame interpolation process, frames with a frame number of “2n+1” (n=0, 1, 2, . . . ) are generated.

At this time, in the frames with a frame number of “2n”, the difference between the input image and the first decoded image is calculated for the difference image. In the frames with a frame number of “2n+1”, the difference between the input image and the frame-interpolated image is calculated for the difference image. For the generated difference image, similarly to the first embodiment, the pixel range conversion and the encoding by the second image encoding unit are performed.

In the generation of the frame interpolation image, the first decoded image may be used with no change. That is, the above process may be performed using the “2n”-th frames as the “2n+1”-th frames. This allows for a considerable reduction in the throughput of the frame interpolation process, although the image quality of the interpolated image is decreased and thereby the encoding efficiency in the second image encoding unit is also decreased.

Furthermore, the second image encoding unit may encode only the frame-interpolated image as the input image. That is, only the frames with a frame number of “2n+1” are encoded. In this case, since it is impossible to perform the prediction from the images of the “2n”-th frames, the encoding efficiency is decreased. However, it is possible to reduce the overhead necessary for the encoding of the “2n”-th frames.

Although the case where the frame rates of the images to be input to the first image encoding unit 101 and the second image encoding unit 104 are predetermined values has been described here, the respective frame rates may be arbitrarily set in the encoding apparatus 1100. In that case, the information indicating the frame rates may be encoded as additional data. As for the encoding method of the additional data, for example, the fifth embodiment can be followed.

### Twelfth Embodiment

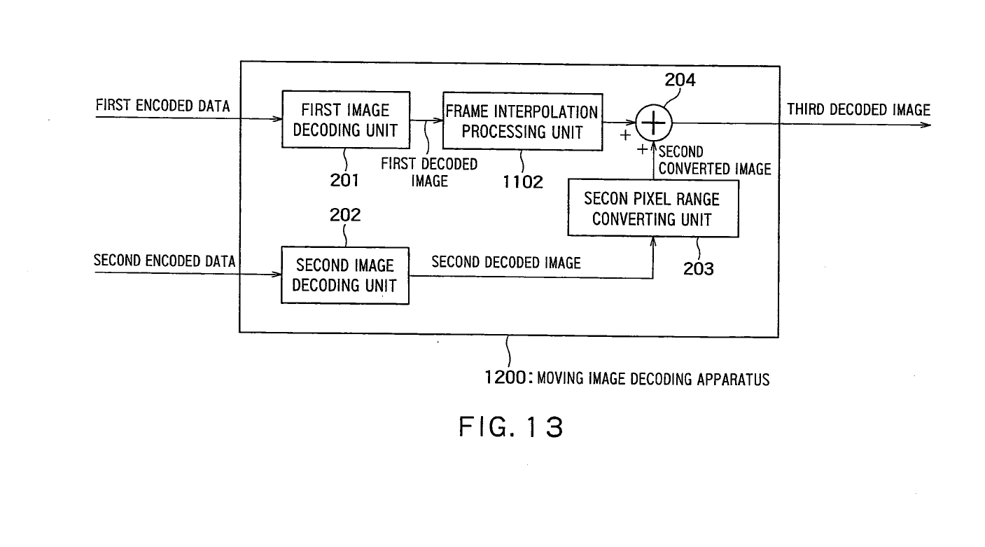

In the embodiment, a moving image decoding apparatus corresponding to the moving image encoding apparatus 1100 according to the eleventh embodiment will be described. In the following, the moving image decoding apparatus according to the embodiment will be described in detail with reference to FIG. 13.

A moving image decoding apparatus 1200 further includes a frame interpolation processing unit 1102, in addition to the constituent elements of the moving image decoding apparatus 200.

The frame interpolation processing unit 1102 receives the first decoded image from the first image decoding unit 201, and performs a predetermined frame interpolation process to output an image whose frame rate has been enhanced.

Here, the frame interpolation processing unit 1102, which is a characteristic of the embodiment, will be described. The frame interpolation processing unit 1102 enhances the frame rate of the first decoded image by performing, for the first decoded image, the same process as the frame interpolation processing unit 1102 in the moving image encoding apparatus 1100 according to the eleventh embodiment. At this time, the second converted image is added to the intermediate frame image generated from the first decoded image by the frame interpolation process, and thereby it is possible to enhance the frame rate of the first decoded image and then enhance the image quality.

In the case where the moving image encoding apparatus 1100 sets an arbitrary frame rate and encodes additional data, as for the format of the additional data, the moving image encoding apparatus 1100 can be followed.

### Thirteen Embodiment

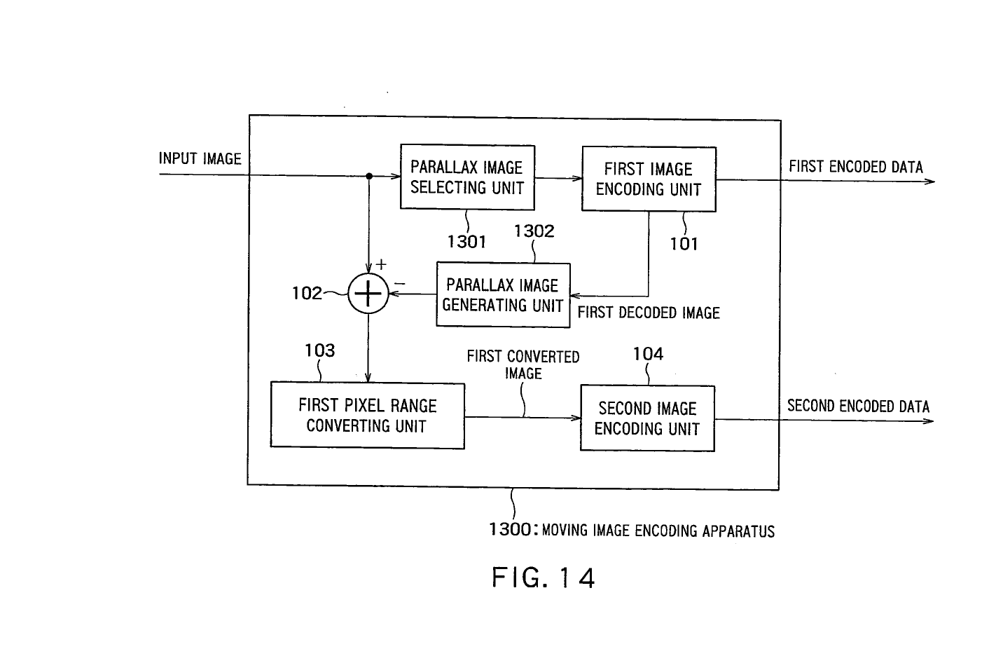

In the embodiment, a modification of the first embodiment will be described. In the following, a moving image encoding apparatus according to the embodiment will be described in detail with reference to FIG. 14.

A moving image encoding apparatus 1300 further includes a parallax image selecting unit 1301 and a parallax image generating unit 1302, in addition to the constituent elements of the moving image encoding apparatus 100. Furthermore, it is assumed that the input image contains moving images for a plurality of parallaxes.

The parallax image selecting unit 1301 receives the input image, selects predetermined parallax images in the input image, and outputs images for the parallaxes.

The parallax image generating unit 1302 receives the first decoded image from the first image encoding unit 101, and performs a predetermined process to generate images corresponding to parallaxes that have not been selected in the parallax image selecting unit 1301.

Here, the parallax image selecting unit 1301 and the parallax image generating unit 1302, which are characteristics of the embodiment, will be described. It is assumed here that the input image is constituted by nine parallax images. In this case, for example, the parallax image selecting unit selects images for five parallaxes, and thereby, the first image encoding unit can generate the first encoded data of the images for the five parallaxes. At this time, the first image encoding unit may independently encode the respective parallax images, or the first image encoding unit may perform the encoding using a codec that is compatible with a multi-parallax encoding using the prediction between parallaxes.

Subsequently, from the first decoded image, the parallax image generating unit 1302 generates images corresponding to the four parallaxes that have not been selected in the parallax image selecting unit 1301. At this time, a general parallax image generation technique may be used, and the image depth information that is obtained from the input image may be used. In this regard, a moving image decoding apparatus described later also needs to perform the same parallax image generation process, and therefore, in the case of using the depth information, it needs to be encoded as additional data. As for the encoding method of the additional data, for example, the fifth embodiment can be followed.

The difference between the parallax image generated by the above and the input image is used as the difference image, and similarly to the first embodiment, the pixel range conversion and the encoding by the second image encoding unit are performed.

Similarly to the case of the frame rate scalability described in the eleventh embodiment, it is allowable to use also the difference between the image selected in the parallax image selecting unit 1301, that is, the first decoded image itself, and the input image, as the difference image, and then perform the subsequent process. Thereby, it is possible to enhance the image quality of the first decoded image. Furthermore, if the second image encoding unit is a codec that is compatible with the prediction between parallaxes, since images that can be used for the prediction are increased, it is possible to enhance also the encoding efficiency for the difference image between the parallax image generated in the parallax image generating unit 1302 and the input image.

So far, the method for implementing the scalability relevant to the number of parallax images has been described. Here, generally, the parallax image, which is used in a 3D picture and the like, means an image that is intended for sufficiently close viewpoints corresponding to the right and left viewpoints of a human. However, by using the above framework, the scalability for a general multi-angle image can be similarly implemented. For example, assuming a system that switches angles for viewing, even if an image from a distant view point, an image for a different view point is generated from a decoded image on a base layer, by a geometric transformation typified by an affine transformation, or the like, and thereby, it is possible to obtain the same effect as the above embodiment.

### Fourteenth Embodiment

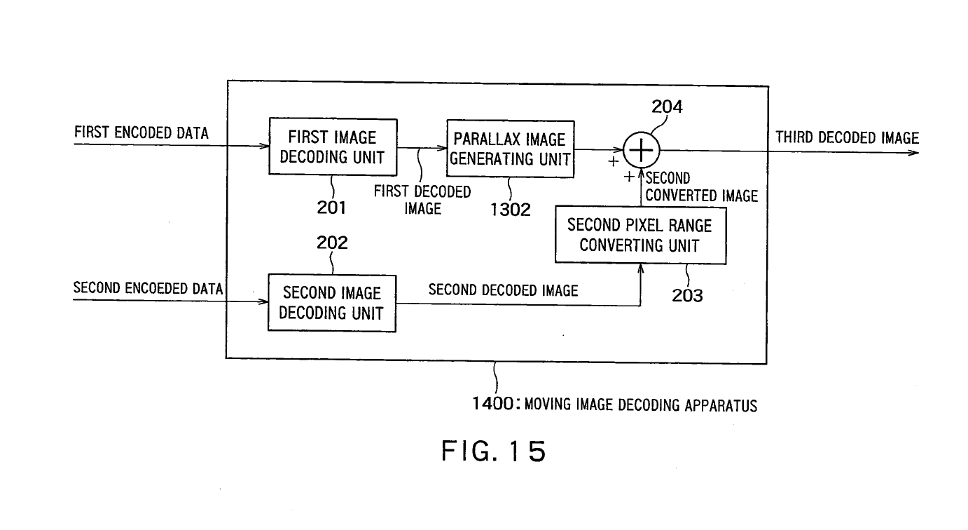

In the embodiment, a moving image decoding apparatus corresponding to the moving image encoding apparatus 1300 according to the thirteenth embodiment will be described. In the following, the moving image decoding apparatus according to the embodiment will be described in detail with reference to FIG. 15.

A moving image decoding apparatus 1400 further includes a parallax image generating unit 1302, in addition to the constituent elements of the moving image decoding apparatus 200.

The parallax image generating unit 1302 receives the first decoded image from the first image decoding unit 201, and performs a predetermined parallax image generation process to generate images corresponding to different parallaxes.

Here, the parallax image generating unit 1302, which is a characteristic of the embodiment, will be described. From the first decoded image, the parallax image generating unit 1302 generates images corresponding to different parallaxes by performing, for the first decoded image, the same process as the parallax image generating unit 1302 in the moving image encoding apparatus 1300 according to the thirteenth embodiment. At this time, the second converted image is added to the intermediate frame image generated from the first decoded image by the parallax image generation process, and thereby it is possible to increase the number of parallaxes of the first decoded image and then enhance the image quality.

In the case where the moving image encoding apparatus 1300 generates the parallax image by utilizing the depth information obtained from the input image and encodes the depth information as additional data, as for the format of the additional data, the moving image encoding apparatus 1300 can be followed.

So far, the embodiments of the present invention have been described. As described above, in the embodiments of the present invention, the scalability is implemented using the two different kinds of codecs and the pixel range converting unit for connecting the codecs. For example, it is possible to perform the pixel range conversion of the difference image between the decoded image (digital broadcast) of an image encoded in MPEG-2 and the input image, and to perform the encoding in H.264 or HEVC. It is possible to calculate the difference image from a same-size image, an extended image, a frame-interpolated image or a parallax image and the corresponding input image, and in this case, it is possible to implement the scalability for the objective image quality, the resolution, the frame rate or the number of parallaxes, respectively. Furthermore, at this time, by generating the difference image after applying a post process such as an image restoration filter to the decoded image of the first codec, it is possible to lessen the pixel range of the difference value and enhance the encoding efficiency in the second codec.

The scalable encoding utilizing the two kinds of codecs allows the enhancement layer to utilize a codec with a higher encoding efficiency than the base layer. Thereby, by utilizing H.264 or HEVC, it is possible to enhance the quality of an image from a digital broadcast by the addition of a small amount of data. Furthermore, this generalizes an H.264 or HEVC decoder, and thereby the encoding scheme in a digital broadcast can be smoothly shifted from MPEG-2 to the new codec.

The instructions that are designated in the processing procedure shown in the above embodiments can be executed based on a program that is software. Also, a general-purpose computer system previously stores this program and reads this program, and thereby it is possible to obtain the same effects as the effects by the above moving image encoding apparatuses and decoding apparatuses. The instructions described in the above embodiments are recoded in a magnetic disk (a flexible disk, a hard disk or the like), an optical disk (CD-ROM, CD-R, CD-RW, DVD-ROM, DVD±R, DVD±RW or the like), a semiconductor memory, or similar kinds of recording media, as a program that can be executed by a computer. The storage format may be any mode, as long as a computer or an embedded system can read the recoding medium. When reading the program from the recoding medium and executing the instructions written in the program with the CPU based on the program, the computer can implement the same operation as the moving image encoding apparatuses and decoding apparatuses in the above embodiments. Naturally, when acquiring or reading the program, the computer may acquire or read it through a network.

Some of the processes for implementing the embodiments may be executed, for example, by an OS (operating system) to operate on a computer based on the instructions of the program that is installed from the recoding medium to the computer or embedded system, database management software, MW (middleware) such as a network.

Furthermore, the recoding medium in the present disclosure includes not only a medium that is independent of the computer or embedded system, but also a recoding medium in which the program transmitted through a LAN, the internet or the like is downloaded and is stored or temporarily stored.

Also, the recoding medium in the present disclosure is not limited to a single recoding medium, and includes a plurality of media from which the processes in the embodiments are executed. The configuration of the media may be any configuration.

Here, the computer or embedded system in the present disclosure, which executes the processes in the embodiments based on the program stored in the recoding medium, may have any configuration, as exemplified by a single apparatus such as a personal computer or a microcomputer, and a system in which a plurality of apparatuses are connected through a network.

The computer in the embodiments of the present disclosure includes not only a personal computer but also an arithmetic processing unit, a microcomputer and others that are contained in an information processing device, and collectively means a device or apparatus that can implement the function in the embodiments of the present disclosure by the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A moving image encoding apparatus comprising:
a first encoding unit to perform a first encoding process on an input image to generate first encoded data and to perform a first decoding process on the first encoded data to generate a first decoded image;
a difference calculating unit to generate a difference image between the input image and the first decoded image;
a first pixel range converting unit to convert pixel values of the difference image to be within a first specific range to generate a first converted image; and
a second encoding unit to perform a second encoding process on the first converted image to generate second encoded data, the second encoding process being different from the first encoding process,
wherein the first specific range is a range including a range of pixel values that can be encoded by the second encoding unit.

2. The apparatus according to claim 1,
wherein the first specific range is a range of 0 or more to a predetermined value or less.

3. The apparatus according to claim 2,
wherein the first pixel range converting unit converts the pixel values of the difference image by adding a first value to the pixel values and then performing a bit shift on the values after the addition.

4. The apparatus according to claim 2,
wherein the first pixel range converting unit converts the pixel values of the difference image by adding a second value to the pixel values and then clips the value after the addition to a predetermined lower limit value when the value after the addition is below the predetermined lower limit value, or to a predetermined upper limit value when the value after the addition is above the predetermined upper limit value.

5. The apparatus according to claim 2,
wherein the first pixel range converting unit converts the pixel values of the difference image based on a maximum value and a minimum value of the pixel values.

6. The apparatus according to claim 5, further comprising,
an encoding unit to encode the maximum value and the minimum value to generate encoded data.

7. The apparatus according to claim 1, further comprising,
a filter processing unit to perform a predetermined filter process on the first decoded image,
wherein the difference calculating unit generates a difference image between the image after the predetermined filter process and the input image.

8. The apparatus according to claim 7,
wherein the filter processing unit performs the predetermined filter process in any unit of a frame, a field, a pixel block and a pixel of the first decoded image, and
the second encoding unit encodes information on the filter process in the unit.

9. The apparatus according to claim 1,
wherein the first specific range is defined for any unit of a frame, a field, a pixel block and a pixel, and
the second encoding unit encodes information on the first specific range in the unit.

10. The apparatus according to claim 1, further comprising:
a downsampling unit to downsample the input image; and
an upsampling unit,
wherein the first encoding unit encodes the input image downsampled by the downsampling unit,
the upsampling unit upsamples the first decoded image, and
the difference calculating unit calculates a difference image between the input image and the image upsampled by the upsampling unit.

11. The apparatus according to claim 1, further comprising:
a frame rate reducing unit to reduce a frame rate of the input image; and
a frame interpolation processing unit,
wherein the first encoding unit encodes the input image the frame rate of which has been reduced by the frame rate reducing unit,
the frame interpolation processing unit performs a frame interpolation of the first decoded image, and
the difference calculating unit calculates a difference image between the input image and the image frame-interpolated by the frame interpolation processing unit.

12. The apparatus according to claim 1, further comprising:
a parallax image selecting unit; and
a parallax image generating unit,
wherein the input image contains a plurality of parallax images corresponding to a plurality of view points,
the parallax image selecting unit selects parallax images corresponding to one or more view points of the view points, from the parallax images,
the first encoding unit encodes the parallax images selected by the parallax image selecting unit to generate the first encoded data,
the parallax image generating unit generates a parallax image corresponding to the viewpoint not selected by the parallax image selecting unit, based on the first decoded image, and
the difference calculating unit calculates a difference image between the input image and the parallax image generated by the parallax image generating unit.

13. A moving image decoding apparatus comprising:
a first image decoding unit to decode first encoded data by a first decoding process to generate a first decoded image;
a second image decoding unit to decode second encoded data by a second decoding process to generate a second decoded image, the second decoding process being different from the first decoding process;
a second pixel range converting unit to convert pixel values of the second decoded image to be within a second specific range to generate a second converted image; and
an adding unit to add the first decoded image and the second converted image to generate a third decoded image.

14. The moving image decoding apparatus according to claim 13,
wherein the second specific range is a range from a negative value of a maximum value of possible pixel values of the first decoded image to the maximum value.

15. A moving image encoding method comprising:
performing a first encoding process on an input image to generate first encoded data and to perform a first decoding process on the first encoded data to generate a first decoded image;
generating a difference image between the input image and the first decoded image;
converting pixel values of the difference image to be within a first specific range to generate a first converted image; and
performing a second encoding process on the first converted image to generate second encoded data, the second encoding process being different from the first encoding process,
wherein the first specific range is a range including a range of pixel values that can be encoded by the second encoding unit.

16. A moving image decoding method comprising:
decoding first encoded data by a first decoding process to generate a first decoded image;
decoding second encoded data by a second decoding process to generate a second decoded image, the second decoding process being different from the first decoding process;
converting pixel values of the second decoded image to be within a second specific range to generate a second converted image; and
adding the first decoded image and the second converted image to generate a third decoded image.

17. The method according to claim 16,
wherein the second specific range is a range from a negative value of a maximum value of possible pixel values of the first decoded image to the maximum value.
